(19) United States
(12) Patent Application Publication
(10) Pub. No.: US 2024/0276087 A1
(43) Pub. Date: Aug. 15, 2024

(54) CAMERA MODULE WITH LENS DRIVER

(71) Applicant: SAMSUNG ELECTRO-MECHANICS CO., LTD., Suwon-si (KR)

(72) Inventors: Jibuem CHUN, Suwon-si (KR); Namki PARK, Suwon-si (KR); Hongjoo LEE, Suwon-si (KR)

(73) Assignee: SAMSUNG ELECTRO-MECHANICS CO., LTD., Suwon-si (KR)

(21) Appl. No.: 18/351,701

(22) Filed: Jul. 13, 2023

(30) Foreign Application Priority Data
Feb. 9, 2023 (KR) 10-2023-0017564

(51) Int. Cl. H04N 23/54; G02B 7/02; G02B 7/08; H02K 41/035; H04N 23/68

(52) U.S. Cl. CPC H04N 23/54; G02B 7/021; G02B 7/08; H02K 41/0356; H04N 23/687

(57) ABSTRACT

A lens driver includes a plurality of first coils disposed on a first substrate extending in a first direction, a second coil disposed on a second substrate extending in a second direction different from the first direction, a first sensing portion disposed on the first substrate, and disposed external to the plurality of first coils so as to not overlap the plurality of first coils along the second direction, a first magnet including a first and second magnet portions that respectively face at least one of the plurality of first coils along the second direction, with different magnetic poles along the first direction, and a second magnet facing the first sensing portion along the second direction, wherein a second distance between the first substrate and the second magnet along the second direction is greater than a first distance between the first substrate and the first magnet along the second direction.

### CROSS-REFERENCE TO RELATED APPLICATION

This application claims the benefit under 35 USC § 119(a) of Korean Patent Application No. 10-2023-0017564 filed on Feb. 9, 2023, in the Korean Intellectual Property Office, the entire contents of which are incorporated herein by reference for all purposes.

### BACKGROUND

### 1. Field

The following description relates to a lens driver.

### 2. Description of Related Art

With the remarkable development of information and communication technology and semiconductor technology, the manufacture and use of electronic devices has rapidly increased. These electronic devices may provide various operations by convergence rather than by being implemented in their typical unique domains.

Recently, cameras have been basically implemented in portable electronic devices such as, but not limited to, smartphones, tablet personal computers (PCs), and laptop computers, and an auto focus (AF) operation, an image stabilization (IS) operation, and a zoom operation has been added to the cameras of these portable electronic devices.

As the form factor of electronic devices on which a camera module is mounted becomes thinner, a thickness of the camera module also becomes thinner, and in order to achieve a thin camera module, it is desirous to reduce the size of component parts.

The above information disclosed in this Background section is only for enhancement of understanding of the background of the disclosure, and therefore it may contain information that does not form the prior art that is already known.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a lens driver includes a plurality of first coils disposed on a first substrate that extends in a first direction, a second coil disposed on a second substrate that extends in a second direction different from the first direction, a first sensing portion disposed on the first substrate, and disposed external to the plurality of first coils so as to not overlap the plurality of first coils along the second direction, a first magnet including a first magnet portion and a second magnet portion that are respectively disposed to face at least one of the plurality of first coils along the second direction, and configured to have different magnetic poles along the first direction, and a second magnet disposed to face the first sensing portion along the second direction, wherein a second distance between the first substrate and the second magnet along the second direction is greater than a first distance between the first substrate and the first magnet along the second direction.

The first sensing portion may be disposed between the first substrate and the second magnet.

A thickness of the first magnet along the second direction may be different from a thickness of the second magnet along the second direction.

The plurality of first coils may be fine pattern (FP) coils which have a pattern integrally formed on the first substrate.

The lens driver may further include a second sensing portion disposed on the second substrate and disposed external to the second coil so as to not overlap the second coil along the first direction, a third magnet disposed to face the second coil along the first direction, and a fourth magnet disposed to the second sensing portion along the first direction, wherein a fourth distance between the second substrate and the fourth magnet along the first direction is greater than a third distance between the second substrate and the third magnet along the first direction.

The second sensing portion may be disposed between the second substrate and the fourth magnet.

A thickness of the third magnet along the first direction may be different from a thickness of the fourth magnet along the first direction.

The second coil may be a fine pattern (FP) coil which has a pattern integrally formed on the second substrate.

The lens driver may further include a first yoke disposed on a rear surface of the first magnet, and a second yoke disposed on a rear surface of the second magnet, wherein the first yoke includes a protrusion that overlaps the first magnet along a third direction perpendicular to the first direction and the second direction, and the second yoke includes a protrusion that overlaps the second magnet along the third direction.

The lens driver may include a third sensing portion disposed on the first substrate and disposed external to the plurality of first coils so as to not overlap the plurality of first coils along the second direction, and a fifth magnet disposed to face the third sensing portion along the second direction, wherein a third distance between the first substrate and the fifth magnet along the second direction may be greater than the first distance between the first substrate and the first magnet.

The third sensing portion may be disposed between the first substrate and the fifth magnet.

A thickness of the first magnet along the second direction may be different from a thickness of the fifth magnet along the second direction.

The lens driver may further include a third yoke disposed on a rear surface of the fifth magnet, wherein the third yoke includes a protrusion that overlaps the fifth magnet along the third direction perpendicular to the first direction and the second direction.

The lens driver may further include a first connection member configured to connect the first magnet and the second magnet, and a second connection member configured to connect the first magnet and the fifth magnet.

The first connection member and the second connection member may be respectively disposed at a first end of the first magnet and a second end of the first magnet along the first direction.

In a general aspect, a lens driver includes a plurality of first coils disposed on a first substrate that extends in a first direction, a second coil disposed on a second substrate that extends in a second direction different from the first direction, a plurality of first sensing portions disposed to respectively overlap the plurality of first coils of the first substrate along the second direction, a second sensing portion disposed to overlap the second coil of the second substrate along the first direction, a first magnet including a first magnet portion and a second magnet portion that are respectively disposed to face at least one of the plurality of first coils along the second direction, and configured to have different magnetic poles along the first direction, and a second magnet disposed to face the second coil along the first direction, wherein the plurality of first coils and the second coil are fine pattern (FP) coils which have a pattern integrally formed on a substrate.

Each of the plurality of first sensing portions may be disposed inside the plurality of first coils.

The plurality of first sensing portions may be embedded inside the first substrate.

The first magnet may be disposed to overlap the plurality of first coils and the plurality of first sensing portions along the second direction.

The lens driver may further include a first yoke disposed on a rear surface of the first magnet, and a second yoke disposed on a rear surface of the second magnet, wherein the first yoke includes a protrusion that overlaps the first magnet along a third direction perpendicular to the first and second directions, and wherein the second yoke includes a protrusion that overlaps the second magnet along the third direction.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates a schematic exploded perspective view of an example camera module, in accordance with one or more embodiments.

FIG. 3 illustrates a top plan view of an example lens driver, in accordance with one or more embodiments.

FIG. 4 illustrates a top plan view of an example lens driver, in accordance with one or more embodiments.

FIG. 5 illustrates a top plan view of an example lens driver, in accordance with one or more embodiments.

FIG. 6 illustrates a top plan view of an example lens driver, in accordance with one or more embodiments.

Throughout the drawings and the detailed description, unless otherwise described or provided, it shall be understood that the same drawing reference numerals refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure. For example, the sequences of operations described herein are merely examples, and are not limited to those set forth herein, but may be changed as will be apparent after an understanding of the disclosure, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples. Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Unless otherwise defined, all terms, including technical and scientific terms, used herein have the same meaning as is commonly understood by one of ordinary skill in the art to which this disclosure pertains. Terms, such as those defined in commonly used dictionaries, should be construed to have meanings matching with contextual meanings in the relevant art and the present disclosure, and are not to be construed as having an ideal or excessively formal meaning unless otherwise defined herein. The use of the term “may” herein with respect to an example or embodiment, e.g., as to what an example or embodiment may include or implement, means that at least one example or embodiment exists where such a feature is included or implemented, while all examples are not limited thereto.

Hereinafter, a first direction DR1 may mean a direction perpendicular to an optical axis. A second direction DR2 may mean a direction perpendicular to the optical axis and the first direction DR1. Additionally, a third direction DR3 may mean a direction parallel to the optical axis and perpendicular to the first direction DR1 and the second direction DR2.

One or more examples may provide a lens driver that may be provided in a thin shape while maintaining a driving force for lens movement without an increase in driving voltage.

In one or more examples, a thin lens driver may be provided while maintaining a driving force to move a lens without increasing a driving voltage.

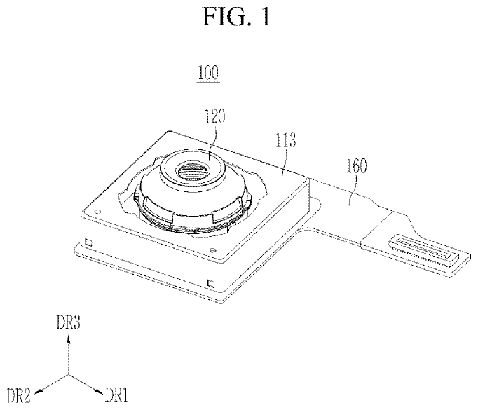

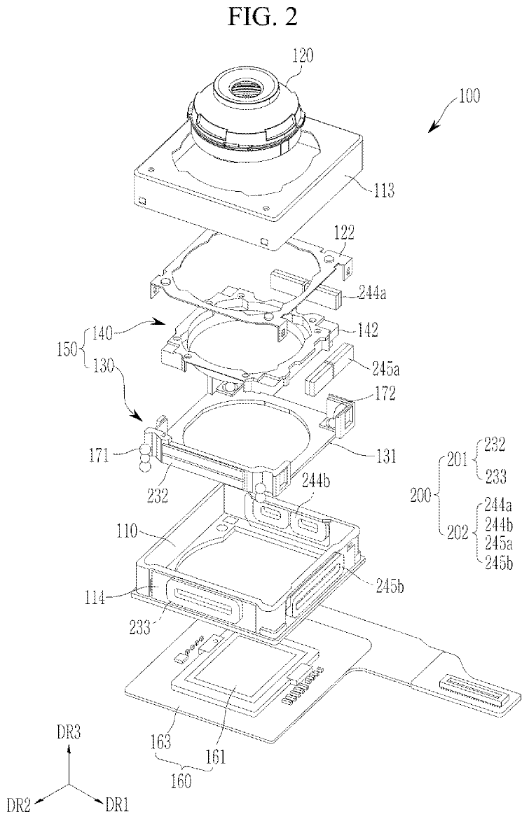

A camera module, in accordance with one or more embodiments, will be described with reference to FIG. 1. FIG. 1 illustrates a perspective view of an example camera module, in accordance with one or more embodiments, and FIG. 2 illustrates a schematic exploded perspective view of an example camera module, in accordance with one or more embodiments.

Referring to FIG. 1 and FIG. 2, an example camera module 100, in accordance with one or more embodiments, may include a lens barrel 120, a lens driving device 150 that moves the lens barrel 120, an image sensor unit 160 that converts light incident through the lens barrel 120 into an electrical signal, a housing 110 that accommodates the lens barrel 120 and the lens driving device 150, and a cover 113.

The lens driving device 150 is a device that moves the lens barrel 120, and may include a focus adjusting unit 130, that adjusts a focus, and a shake correcting unit 140 that corrects hand-shake.

The focus adjusting unit 130 may include a carrier 131 that accommodates the lens barrel 120, and a focus adjusting driver 201 that generates a driving force to move the lens barrel 120 and the carrier 131 in an optical axis direction.

The focus adjusting driver 201 may include a magnet 232 and a coil 233. The magnet 232 of the focus adjusting driver 201 may be mounted on one surface of the carrier 131, and the coil 233 may be formed in a substrate 114 to be mounted on the housing 110.

When power from a power source is applied to the coil 233, the carrier 131 may be moved in an optical axis direction by the electromagnetic force between the magnet 232 and the coil 233. Since the lens barrel 120 is accommodated in the carrier 131, the lens barrel 120 may also be moved in the optical axis direction based on the movement of the carrier 131.

When the carrier 131 is moved, a first rolling member 171 may be disposed between the carrier 131 and the housing 110, and may reduce friction between the carrier 131 and the housing 110. In an example, the first rolling member 171 may be in a form of a ball, and may be disposed at both sides of the magnet 232. A guide groove may be formed in the carrier 131 so that the first rolling member 171 is accommodated and guided in the optical axis direction.

The shake correcting unit 140 includes a lens holder 142 that guides movement of the lens barrel 120 and a shake correcting driver 202 that generates a driving force to move the lens holder 142 in a direction perpendicular to the optical axis direction.

The lens holder 142 is inserted into the carrier 131 to be disposed in the optical axis direction, and guides a movement of the lens barrel 120. The lens holder 142 may have a substantially quadrangular frame shape. Magnets 244a and 245a, which perform hand-shake correction, may be disposed on two adjacent side surfaces of the lens holder 142.

The shake correcting driver 202 may include the magnets 244a and 245a and coils 244b and 245b. The magnets 244a and 245a of the shake correcting driver 202 may be mounted on the lens holder 142, and the coils 244b and 245b respectively facing the magnets 244a and 245a may be formed on the substrate 114 to be fixedly mounted on the housing 110 via the substrate 114.

A plurality of second rolling members 172 may be provided to support the shake correcting unit 140, and the plurality of second rolling members 172 may guide the lens holder 142 in the shake correcting process. Additionally, the second rolling members 172 may also maintain a distance between the carrier 131 and the lens holder 142.

The image sensor unit 160 is a device that converts light incident through the lens barrel 120 into an electrical signal. In an example, the image sensor unit 160 may include an image sensor 161 and a printed circuit board 163 connected to the image sensor 161, and may further include an infrared filter. The infrared filter blocks light in an infrared region among light incident through the lens barrel 120.

The image sensor 161 converts light incident through the lens barrel 120 into an electrical signal. For example, the image sensor 161 may be a charge coupled device (CCD) or a complementary metal-oxide semiconductor (CMOS). The electrical signal converted by the image sensor 161 is outputted as an image through a display unit of a portable electronic device. The image sensor 161 is fixed to the printed circuit board 163, and may be electrically connected to the printed circuit board 163.

The lens barrel 120 and the lens driving device are accommodated in a space inside the housing 110, and for example, the housing 110 may have a box shape in which upper and lower portions are opened. The image sensor unit 160 is disposed at a lower portion of the housing 110.

A stopper 122 may be further disposed at an upper portion of the lens barrel 120 to prevent a frame 141 and the lens holder 142 from being separated from an inner space of the carrier 131, and the stopper 122 may be combined with the carrier 131.

The cover 113 is combined with the housing 110 to cover an outer surface of the housing 110, and may protect internal components of the camera module. In an example, the cover 113 may have a boss structure for coupling with the housing 110 or other components on one surface thereof. Additionally, the cover 113 may shield electromagnetic waves. In an example, the cover 113 may shield electromagnetic waves so that electromagnetic waves generated by the camera module do not affect other electronic components in a portable electronic device.

Additionally, since the portable electronic device is equipped with several electronic components in addition to the camera module, the cover 113 may shield electromagnetic waves so that electromagnetic waves generated from these electronic components do not affect the camera module. The cover 113 may be provided with a metallic material to be grounded to a ground pad provided in the printed circuit board 163, thereby shielding electromagnetic waves.

Hereinafter, the lens driver, which is the shake correcting driver described above, will be described in more detail.

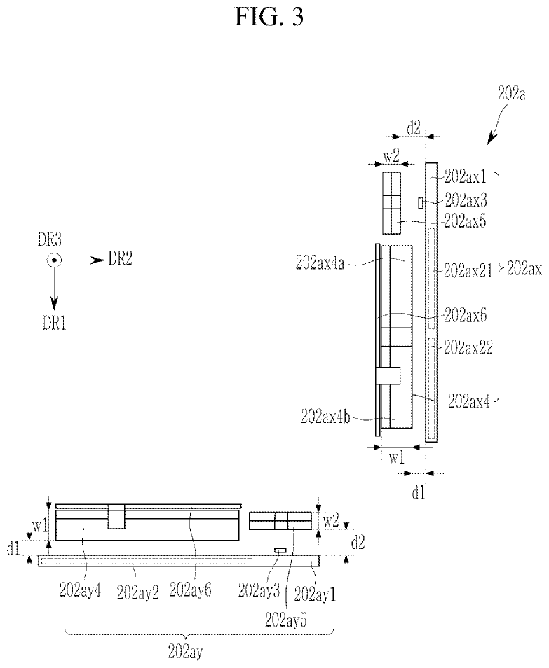

Referring to FIG. 3, a lens driver, in accordance with one or more embodiments, will be described. FIG. 3 illustrates a top plan view of a lens driver, in accordance with one or more embodiments.

Referring to FIG. 3, a lens driver 202a, in accordance with one or more embodiments, may include a first lens driver 202ax extending in parallel with the first direction DR1, and a second lens driver 202ay extending in parallel with the second direction DR2 different from the first direction DR1.

The first lens driver 202ax may include a substrate 202ax1, a plurality of coils 202ax21 and 202ax22, a sensing portion 202ax3, a first magnet 202ax4, a second magnet 202ax5, and a yoke 202ax6.

The plurality of coils 202ax21 and 202ax22 of the first lens driver 202ax may be formed in the substrate 202ax1. In an example, the plurality of coils 202ax21 and 202ax22 may be winding coils or fine pattern (FP) coils embedded in the substrate 202ax1. The FP coil may have an integrally formed pattern on the substrate. Additionally, the FP coil may be formed in a plate shape, so it may be easily attached to the housing 110.

The sensing portion 202ax3 may include a sensor such as, but not limited to, a Hall sensor, and may be disposed outside the plurality of coils 202ax21 and 202ax22 on the substrate 202ax1. The sensing portion 202ax3 may not overlap the plurality of coils 202ax21 and 202ax22 along the first direction DR1 and the third direction DR3 in which the substrate 202ax1 extends. Additionally, the sensing portion 202ax3 may also not overlap the plurality of coils 202ax21 and 202ax22 along the second direction DR2. The second direction DR2 is perpendicular to the first direction DR1 and the third direction DR3, and may be a direction in which the substrate 202ax1 and the first magnet 202ax4 and the second magnet 202ax5 face each other.

The first magnet 202ax4 and the second magnet 202ax5 of the first lens driver 202ax may be separated to be spaced apart from each other. The first magnet 202ax4 may face the plurality of coils 202ax21 and 202ax22 along the second direction DR2. The first magnet 202ax4 may include a first magnet portion 202ax4a and a second magnet portion 202ax4b respectively facing at least one of the plurality of coils 202ax21 and 202ax22 along the second direction DR2. In an example, the first magnet portion 202ax4a and the second magnet portion 202ax4b may have different magnetic poles along the first direction DR1. The second magnet 202ax5 may face the sensing portion 202ax3 along the second direction DR2 and at least partially face the plurality of coils 202ax21 and 202ax22.

In a distance measured along the second direction DR2, a second distance d2 between the substrate 202ax1 and the second magnet 202ax5 may be greater than a first distance d1 between the substrate 202ax1 and the first magnet 202ax4. A distance from which the second magnet 202ax5 is separated from the surface of the substrate 202ax1 along the second direction DR2 may be greater than a distance from which the first magnet 202ax4 is separated from the surface of the substrate 202ax1 along the second direction DR2.

In a thickness along the second direction DR2, a first thickness w1 of the first magnet 202ax4 and a second thickness w2 of the second magnet 200ax5 may be different from each other. In an example, in the thickness along the second direction DR2, the first thickness w1 of the first magnet 202ax4 may be greater than the second thickness w2 of the second magnet 200ax5. In a non-limited example, a surface of the first magnet 202ax4 and a surface of the second magnet 200ax5 may be aligned and disposed along the first direction DR1. In the thickness along the second direction DR2 from the surface on which the first magnet 202ax4 and the second magnet 202ax5 are aligned and disposed, the thickness of the first magnet 202ax4 may be greater than the thickness of the second magnet 202ax5.

In an example, the yoke 202ax6 may be disposed on a rear surface of the first magnet 202ax4. The yoke 202ax6 may be flat along the first direction DR1. The yoke 202ax6 may include a protrusion overlapping the first magnet 202ax4 along the third direction DR3.

In a non-limited example, along the second direction DR2, the sensing portion 202ax3 may be disposed between the substrate 202ax1 and the second magnet 202ax5. The second magnet 202ax5 may be disposed farther from the substrate 202ax1 than the first magnet 202ax4, so that a space in which the sensing portion 202ax3 may be disposed is secured between the substrate 202ax1 and the second magnet 202ax5. Additionally, a relatively small first distance d1 may be maintained between the first magnet 202ax4 and the coil 202ax22 formed in the substrate 202ax1, so that the driving force due to the electromagnetic force between the first magnet 202ax4 and the coil 202ax22 formed in the substrate 202ax1 may not decrease.

When the distance between the substrate 202ax1 and the first magnet 202ax4 is the same as the distance between the substrate 202ax1 and the second magnet 202ax5, in order to maintain a space to dispose the sensing portion 202ax3, a distance between the substrate 202ax1 and the first magnet 202ax4 may be the second distance d2. Additionally, compared to the example in which the distance between the substrate 202ax1 and the first magnet 202ax4 is the first distance d1, the distance between the substrate 202ax1 and the first magnet 202ax4 may be widened. As described above, when the distance between the substrate 202ax1 and the first magnet 202ax4 is widened and when the same driving voltage is applied, the electromagnetic force between the first magnet 202ax4 and the plurality of coils 202ax21 and 202ax22 disposed in the substrate 202ax1 may decrease, and thus the driving voltage applied to the lens driver may increase.

However, as described above, in the lens driver, in accordance with one or more embodiments, the plurality of coils 202ax21 and 202ax22 may be formed in the substrate 202ax1, and the second magnet 202ax5 facing the sensing portion 202ax3 may be disposed farther from the substrate 202ax1 than the first magnet 202ax4 facing the plurality of coils 202ax21 and 202ax22, so that the sensing portion 202ax3 may be disposed between the substrate 202ax1 and the second magnet 202ax5. Accordingly, a decrease in the electromagnetic force between the first magnet 202ax4 and the substrate 202ax1 may be prevented, so that the lens driving force may be maintained without increasing the driving voltage applied to the lens driver. Additionally, by forming the plurality of coils 202ax21 and 202ax22 of the lens driver in the substrate 202ax1, the lens driver may be implemented in a thin shape.

Similar to the first lens driver 202ax, the second lens driver 202ay may include a substrate 202ay1, a coil 202ay2, a sensing portion 202ay3, a first magnet 202ay4, a second magnet 202ay5, and a yoke 202ay6.

The coil 202ay2 of the second lens driver 202ay may be a winding coil embedded in the substrate 202ay1 or a fine pattern (FP) coil. The FP coil may have an integrally formed pattern on the substrate. Additionally, the FP coil may be formed in a plate shape, so it may be easily attached to the housing 110.

The sensing portion 202ay3 may include a sensor such as, but not limited to, a Hall sensor, and may be disposed outside the coil 202ay2 on the substrate 202ay1. The sensing portion 202ay3 may not overlap the coil 202ay2 along the second direction DR2 and the third direction DR3 in which the substrate 202ay1 extends. Additionally, the sensing portion 202ay3 may not overlap the coil 202ay2 along the first direction DR2. The first direction DR1 is perpendicular to the second direction DR2 and the third direction DR3, and may be a direction in which the substrate 202ay1 and the first magnet 202ay4 and the second magnet 202ay5 face each other.

The first magnet 202ay4 and the second magnet 202ay5 of the second lens driver 202ay are separated to be spaced apart from each other, the first magnet 202ay4 may face the coil 202ay2 along the first direction DR1, and the second magnet 202ay5 may face the sensing portion 202ay3 and may at least partially face the coil 202ay2. The second magnet 202ay5 may include first and second magnet portions having different magnetic poles.

In a distance measured along the first direction DR1, the second distance d2 between the substrate 202ay1 and the second magnet 202ay5 may be greater than the first distance d1 between the substrate 202ay1 and the first magnet 202ay4. A distance from which the second magnet 202ay5 is separated from the surface of the substrate 202ay1 along the first direction DR1 may be greater than a distance from which the first magnet 202ay4 is separated from the surface of the substrate 202ay1 along the first direction DR1.

In a thickness along the first direction DR1, the first thickness w1 of the first magnet 202ay4 and the second thickness w2 of the second magnet 202ay5 may be different from each other. In an example, in the thickness along the first direction DR1, the first thickness w1 of the first magnet 202ay4 may be greater than the second thickness w2 of the second magnet 202ay5. In a non-limited example, the surface of the first magnet 202ay4 and the surface of the second magnet 200ay5 may be aligned, and may be disposed along the second direction DR2. In the thickness along the first direction DR1 from the surface on which the first magnet 202ay4 and the second magnet 202ay5 are aligned and disposed, the thickness of the first magnet 202ay4 may be greater than the thickness of the second magnet 202ay5.

In an example, the yoke 202ay6 may be disposed on a rear surface of the first magnet 202ay4. The yoke 202ax6 may be flat along the second direction DR2. The yoke 202ay6 may include a protrusion overlapping the first magnet 202ay4 along the third direction DR3.

Along the first direction DR1, the sensing portion 202ay3 may be disposed between the substrate 202ay1 and the second magnet 202ay5. The second magnet 202ay5 may be disposed farther from the substrate 202ay1 than the first magnet 202ay4, so that a space in which the sensing portion 202ay3 may be disposed is secured between the substrate 202ay1 and the second magnet 202ay5. Additionally, a relatively small first distance d1 may be maintained between the first magnet 202ay4 and the coil 202ay2 formed in the substrate 202ay1, so that the driving force due to the electromagnetic force between the first magnet 202ay4 and the coil 202ay2 formed in the substrate 202ay1 may not decrease, thereby preventing an increase in driving voltage. Additionally, by embedding the coil 202ay2 of the second lens driver 202ay in the substrate 202ay1, the second lens driver 202ay may have a thin form factor.

The sensing portion 202ax3, the second magnet 202ax5, and the plurality of coils 202ax21 and 202ax22 of the first lens driver 202ax may detect a position change of the lens barrel in a direction parallel to the second direction DR2. Additionally, in order to correct the position change, the plurality of coils 202ax21 and 202ax22 and the first magnet 202ax4 of the first lens driver 202ax may move the lens barrel in a direction parallel to the second direction DR2. The sensing portion 202ay3, the second magnet 202ay5, and the coil 202ay2 of the second lens driver 202ay may sense a position change of the lens barrel according to a direction parallel to first direction DR1 and second direction DR2. Additionally, in order to correct the position change, the coil 202ay2 and the first magnet 202ay4 of the second lens driver 202ay may move the lens barrel in a direction parallel to the first direction DR1.

In a non-limited example, the substrate 202ax1 of the first lens driver 202ax and the substrate 202ay1 of the second lens driver 202ay may be one substrate connected to each other.

As described with reference to FIG. 1 and FIG. 2, the focus adjusting driver 201 may generate a driving force to move the lens barrel 120 in the optical axis direction, for example, in the third direction DR3, and the shake correcting driver 202 may generate a driving force to move the lens barrel 120 in the first and second directions DR1 and DR2 perpendicular to the third direction DR3.

In an example, the first lens driver 202ax and the second lens driver 202ay of the lens driver 202a may be the shake correcting driver 202, and when a shaking error occurs in the camera module, and they may move the lens barrel 120 in the first and second directions DR1 and DR2 perpendicular to the third direction DR3 to correct movement caused by shaking.

In an example, the sensing portion 202ax3 of the first lens driver 202ax may collect sensor information according to the movement of the lens barrel 120 in the second direction DR2. The sensing portion 202ay3 of the second lens driver 202ay may collect sensor information according to the movement of the lens barrel 120 in the first direction DR1 and the second direction DR2. The sensing portion 202ax3 of the first lens driver 202ax and the sensing portion 202ay3 of the second lens driver 202ay may be electrically connected to the printed circuit board 163. Additionally, the sensing portion 202ax3 of the first lens driver 202ax and the sensing portion 202ay3 of the second lens driver 202ay may transmit the collected sensor information to a first processor (for example, a control circuit) of the camera module 100 through the printed circuit board 163, or a second processor of the electronic device on which the camera module 100 is mounted. The printed circuit board 163 may be connected to the first processor (or the control circuit) related to driving the camera module 100 or the second processor of the electronic device on which the camera module 100 is mounted.

According to the control of at least one of the first processor and the second processor, the printed circuit board 163 may supply a signal of a specified magnitude (for example: a current of a specified magnitude) to at least one of the plurality of coils 202ax21 and 202ax22 and the coil 202ay2. Accordingly, rotation occurring in the lens module 120 may be compensated to prevent deterioration of image quality of the camera module 100. As a specific example, at least one of the plurality of coils 202ax21 and 202ax22 may be controlled so that a sum of a value of the sensor information according to the movement of the lens barrel 120 in the second direction DR2 collected by the sensing portion 202ax3 of the first lens driver 202ax and a value of the sensor information according to the movement of the lens barrel 120 in the second direction DR2 collected by the sensing portion 202ay3 of the second lens driver 202ay becomes zero. In this example, processing such as linear regression may be performed on the sensor information.

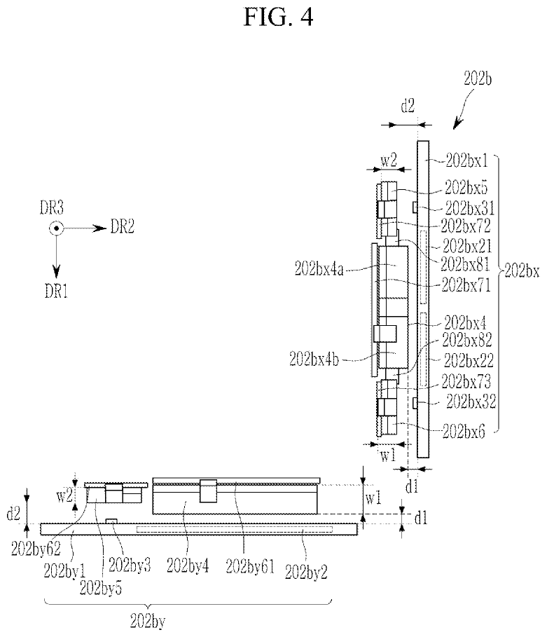

Hereinafter, an example lens driver, in accordance with one or more embodiments, will be described with reference to FIG. 4. FIG. 4 illustrates a top plan view of an example lens driver, in accordance with one or more embodiments.

Referring to FIG. 4, a lens driver 202b, in accordance with one or more embodiments, may include a first lens driver 202bx extending in parallel to the first direction DR1, and a second lens driver 202by extending in parallel to the second direction DR2 different from the first direction DR1.

The first lens driver 202bx includes a substrate 202bx1, a plurality of coils 202bx21 and 202bx22, a first sensing portion 202bx31, a second sensing portion 202bx32, a first magnet 202bx4, a second magnet 202bx5, a third magnet 202bx6, a first yoke 202bx71, a second yoke 202bx72, a third yoke 202bx73, a first connection member 202bx81, and a second connection member 202bx82.

The plurality of coils 202bx21 and 202bx22 of the first lens driver 202bx may be formed in the substrate 202bx1. In an example, the plurality of coils 202bx21 and 202bx22 may be winding coils or fine pattern (FP) coils embedded in the substrate 202bx1. The FP coil may have an integrally formed pattern on the substrate. Additionally, in an example, the FP coil may be formed in a plate shape, so it may be easily attached to the housing 110.

The first sensing portion 202bx31 and the second sensing portion 202bx32 may include a sensor such as, but not limited to, a Hall sensor, and may be disposed outside the plurality of coils 202bx21 and 202bx22 on the substrate 202bx1. In an example, the first sensing portion 202bx31 and the second sensing portion 202bx32 may not overlap the plurality of coils 202bx21 and 202bx22 along the first direction DR1 and the third direction DR3 in which the substrate 202bx1 extends. Additionally, in an example, the first sensing portion 202bx31 and the second sensing portion 202bx32 may not overlap the plurality of coils 202bx21 and 202bx22 along the second direction DR2. The second direction DR2 is perpendicular to the first direction DR1 and the third direction DR3, and may be a direction in which the substrate 202bx1 and the first magnet 202bx4, the second magnet 202bx5, and the third magnet 202bx6 face each other.

The first magnet 202bx4, the second magnet 202bx5, and the third magnet 202bx6 of the first lens driver 202bx may be separated from each other and spaced apart from each other. The first magnet 202bx4 may face the plurality of coils 202bx21 and 202bx22 along the second direction DR2. The first magnet 202bx4 may include a first magnet portion 202bx4a and a second magnet portion 202bx4b respectively facing at least one of the plurality of coils 202bx21 and 202bx22 along the second direction DR2. The first magnet portion 202bx4a and the second magnet portion 202bx4b may have different magnetic poles along the first direction DR1. The second magnet 202bx5 may face the first sensing portion 202bx31 along the second direction DR2 and at least partially face the plurality of coils 202bx21 and 202bx22. The third magnet 202bx6 may face the second sensing portion 202bx32 along the second direction DR2 and at least partially face the plurality of coils 202bx21 and 202bx22.

A first connection member 202bx81 and a second connection member 202bx82 may be disposed at both ends of the first magnet 202bx4 along the first direction DR1. The first connection member 202bx81 may connect the first magnet 202bx4 and the second magnet 202bx5. The second connection member 202bx82 may connect the first magnet 202bx4 and the third magnet 202bx6.

In a distance measured along the second direction DR2, a second distance d2 between the substrate 202bx1 and the second magnet 202bx5 or the third magnet 202bx6 may be greater than a first distance d1 between the substrate 202bx1 and the first magnet 202bx4. A distance from which the second magnet 202bx5 is separated from the surface of the substrate 202bx1 along the second direction DR2 may be greater than a distance from which the first magnet 202bx4 is separated from the surface of the substrate 202bx1 along the second direction DR2.

In a thickness along the second direction DR2, a first thickness w1 of the first magnet 202bx4 and a second thickness w2 of the second magnet 202bx5 or the third magnet 202bx6 may be different from each other. For example, in the thickness along the second direction DR2, the first thickness w1 of the first magnet 202bx4 may be greater than the second thickness w2 of the second magnet 202bx5 or the third magnet 202bx6. In an example, a surface of the first magnet 202bx4 and a surface of the second magnet 202bx5 or the third magnet 202bx6 may be aligned and disposed along the first direction DR1. In the thickness along the second direction DR2 from the surface on which the first magnet 202bx4 and the second magnet 202bx5 or the third magnet 202bx6 are aligned and disposed, the thickness of the first magnet 202bx4 is greater than the thickness of the second magnet 202bx5 or the third magnet 202bx6.

The first yoke 202bx71 may be disposed on a rear surface of the first magnet 202bx4. The first yoke 202bx71 may be flat along the first direction DR1. The first yoke 202bx71 may include a protrusion overlapping the first magnet 202bx4 along the third direction DR3.

The second yoke 202bx72 may be disposed on a rear surface of the second magnet 202bx5. The second yoke 202bx72 may be flat along the first direction DR1. The second yoke 202bx72 may include a protrusion overlapping the second magnet 202bx5 along the second direction DR2.

The third yoke 202bx73 may be disposed on a rear surface of the third magnet 202bx6. The third yoke 202bx73 may be flat along the first direction DR1. The third yoke 202bx73 may include a protrusion overlapping the third magnet 202bx6 along the third direction DR3.

Along the second direction DR2, the first sensing portion 202bx31 may be disposed between the substrate 202bx1 and the second magnet 202bx5. The second magnet 202bx5 may be disposed farther from the substrate 202bx1 than the first magnet 202bx4, so that a space in which the first sensing portion 202bx31 may be disposed is secured between the substrate 202bx1 and the second magnet 202bx5. Along the second direction DR2, the second sensing portion 202bx32 may be disposed between the substrate 202bx1 and the third magnet 202bx6. The third magnet 202bx6 may be disposed farther from the substrate 202bx1 than the first magnet 202bx4, so that a space in which the second sensing portion 202bx32 may be disposed is secured between the substrate 202bx1 and the third magnet 202bx6. Additionally, a relatively small first distance d1 is maintained between the first magnet 202bx4 and the plurality of coils 202bx21 and 202bx22 formed in the substrate 202bx1, so that the driving force due to the electromagnetic force between the first magnet 202bx4 and the plurality of coils 202bx21 and 202bx22 formed in the substrate 202bx1 may not decrease.

When the distance between the substrate 202bx1 and the first magnet 202bx4 is the same as the distance between the substrate 202bx1 and the second magnet 202bx5 and the second magnet 202bx6, in order to maintain a space to dispose the first sensing portion 202bx31 and the second sensing portion 202bx32, a distance between the substrate 202bx1 and the first magnet 202bx4 may be the second distance d2. Additionally, compared to the example in which the distance between the substrate 202bx1 and the first magnet 202bx4 is the first distance d1, the distance between the substrate 202bx1 and the first magnet 202bx4 may be widened. As described above, when the distance between the substrate 202bx1 and the first magnet 202bx4 is widened, and when the same driving voltage is applied, the electromagnetic force between the first magnet 202bx4 and the plurality of coils 202bx21 and 202bx22 disposed in the substrate 202bx1 may decrease, and thus the driving voltage applied to the lens driver may increase.

However, as described above, in the example lens driver, in accordance with one or more embodiments, the plurality of coils 202bx21 and 202bx22 are formed in the substrate 202bx1, and the second magnet 202bx5 and the third magnet 202bx6 respectively facing the first sensing portion 202bx31 and the second sensing portion 202bx32 may be disposed farther from the substrate 202bx1 than the first magnet 202bx4 facing the plurality of coils 202bx21 and 202bx22, so that first sensing portion 202bx31 and the second sensing portion 202bx32 may be disposed between the substrate 202bx1 and the second magnet 202bx5 and the third magnet 202bx6. Accordingly, a decrease in the electromagnetic force between the first magnet 202bx4 and the substrate 202bx1 may be prevented, so that the lens driving force may be maintained without increasing the driving voltage applied to the lens driver. Additionally, by forming the plurality of coils 202bx21 and 202bx22 of the lens driver in the substrate 202bx1, the lens driver may be implemented in a thin shape.

Similar to the first lens driver 202bx, the second lens driver 202by may include a substrate 202by1, a coil 202by2, a sensing portion 202by3, a first magnet 202by4, a second magnet 202by5, a first yoke 202by61, and a second yoke 202by62.

The coil 202by2 of the second lens driver 202by may be a winding coil inside the substrate 202by1 or a fine pattern (FP) coil. The FP coil may have an integrally formed pattern on the substrate. In addition, the FP coil may be formed in a plate shape, so it may be easily attached to the housing 110.

The sensing portion 202by3 may include a sensor such as, but not limited to, a Hall sensor, and may be disposed outside the coil 202by2 on the substrate 202by1. The sensing portion 202by3 may not overlap the coil 202by2 along the second direction DR2 and the third direction DR3 in which the substrate 202by1 extends. Additionally, the sensing portion 202by3 may not overlap the coil 202by2 along the first direction DR2. The first direction DR1 is perpendicular to the second direction DR2 and the third direction DR3, and may be a direction in which the substrate 202by1 and the first magnet 202by4 and the second magnet 202by5 face each other.

The first magnet 202by4 and the second magnet 202by5 of the second lens driver 202by are separated and spaced apart from each other, and the first magnet 202by4 may face the coil 202by2 along the first direction DR1. The second magnet 202by5 may face the sensing portion 202by3, and at least partly face the coil 202by2.

In a distance measured along the first direction DR1, a second distance d2 between the substrate 202by1 and the second magnet 202by5 may be greater than the first distance d1 between the substrate 202by1 and the first magnet 202by4. A distance from which the second magnet 202by5 is separated from the surface of the substrate 202by1 along the first direction DR1 may be greater than a distance from which the first magnet 202by4 is separated from the surface of the substrate 202by1 along the first direction DR1.

In a thickness along the first direction DR1, the first thickness w1 of the first magnet 202by4 and the second thickness w2 of the second magnet 202by5 may be different from each other. In an example, in the thickness along the first direction DR1, the first thickness w1 of the first magnet 202by4 may be greater than the second thickness w2 of the second magnet 202by5. In an example, the surface of the first magnet 202by4 and the surface of the second magnet 200by5 may be disposed substantially in line along the second direction DR2. In the thickness along the first direction DR1 from the surface on which the first magnet 202by4 and the second magnet 202by5 are aligned and disposed, the thickness of the first magnet 202by4 may be greater than the thickness of the second magnet 202by5.

The first yoke 202by61 may be disposed on a rear surface of the first magnet 202by4. The first yoke 202bx61 may be flat along the second direction DR2. The second yoke 202by62 may be disposed on a rear surface of the second magnet 202by5. The second yoke 202bx62 may be flat along the second direction DR2.

Along the first direction DR1, the sensing portion 202by3 may be disposed between the substrate 202by1 and the second magnet 202by5. The second magnet 202by5 may be disposed farther from the substrate 202by1 than the first magnet 202by4, so that a space in which the sensing portion 202by3 may be disposed is secured between the substrate 202by1 and the second magnet 202by5. Additionally, a relatively small first distance d1 is maintained between the first magnet 202by4 and the coil 202by2 formed in the substrate 202by1, so that the driving force due to the electromagnetic force between the first magnet 202by4 and the coil 202by2 formed in the substrate 202by1 may not decrease, thereby preventing an increase in driving voltage. Additionally, by embedding the coil 202by2 of the second lens driver 202by in the substrate 202by1, the second lens driver 202by may have a thin form factor.

The first sensing portion 202bx31, the second magnet 202bx5, and the plurality of coils 202bx21 and 202bx22 of the first lens driver 202bx may detect a position change of the lens barrel in a direction parallel to the second direction DR2. Additionally, the second sensing portion 202bx32, the third magnet 202bx6, and the plurality of coils 202bx21 and 202bx22 of the first lens driver 202bx may also sense a position change of the lens barrel in a direction parallel to the second direction DR2. In order to correct the position change, the plurality of coils 202bx21 and 202bx22 and the first magnet 202bx4 of the first lens driver 202bx may move the lens barrel in a direction parallel to the second direction DR2. The sensing portion 202by3, the second magnet 202by5, and the coil 202by2 of the second lens driver 202by may sense a position change of the lens barrel according to a direction parallel to first direction DR1. Additionally, in order to correct the position change, the coil 202by2 and the first magnet 202by4 of the second lens driver 202by may move the lens barrel in a direction parallel to the first direction DR1.

In an example, the substrate 202bx1 of the first lens driver 202bx and the substrate 202by1 of the second lens driver 202by may be one substrate connected to each other.

As described with reference to FIG. 1 and FIG. 2, the focus adjusting driver 201 may generate a driving force to move the lens barrel 120 in the optical axis direction, for example, in the third direction DR3, and the shake correcting driver 202 may generate a driving force to move the lens barrel 120 in the first and second directions DR1 and DR2 perpendicular to the third direction DR3.

The first lens driver 202bx and the second lens driver 202by of the lens driver 202b may be the shake correcting driver 202, and when a shaking error occurs in the camera module, they may move the lens barrel 120 in the first and second directions DR1 and DR2 perpendicular to the third direction DR3 to correct movement caused by hand shaking.

In an example, the first sensing portion 202bx31 and the second sensing portion 202bx32 of the first lens driver 202bx may collect sensor information according to the movement of the lens barrel 120 in the second direction DR2. The sensing portion 202by3 of the second lens driver 202by may collect sensor information according to the movement of the lens barrel 120 in the first direction DR1. The first sensing portion 202bx31 and the second sensing portion 202bx32 of the first lens driver 202bx and the sensing portion 202by3 of the second lens driver 202by may be electrically connected to the printed circuit board 163. Additionally, the first sensing portion 202bx31 and the second sensing portion 202bx32 of the first lens driver 202bx, and the sensing portion 202by3 of the second lens driver 202by, may transmit the collected sensor information to a first processor (for example, a control circuit) of the camera module 100 through the printed circuit board 163 or a second processor of the electronic device on which the camera module 100 is mounted. The printed circuit board 163 may be connected to the first processor (or the control circuit) related to driving the camera module 100 or the second processor of the electronic device on which the camera module 100 is mounted.

According to the control of at least one of the first processor and the second processor, the printed circuit board 163 may supply a signal of a specified magnitude (for example: a current of a specified magnitude) to at least one of the plurality of coils 202bx21 and 202bx22 and the coil 202by. Accordingly, rotation occurring in the lens module 120 may be compensated to prevent deterioration of image quality of the camera module 100. As a specific example, at least one of the plurality of coils 202bx21 and 202bx22 may be controlled so that a sum of a value of the sensor information according to the movement of the lens barrel 120 in the second direction DR2 collected by the first sensing portion 202bx31 of the first lens driver 202bx, and a value of the sensor information according to the movement of the lens barrel 120 in the second direction DR2 collected by the second sensing portion 202bx32 of the first lens driver 202bx becomes zero. In this example, processing such as, but not limited to, linear regression may be performed on the sensor information.

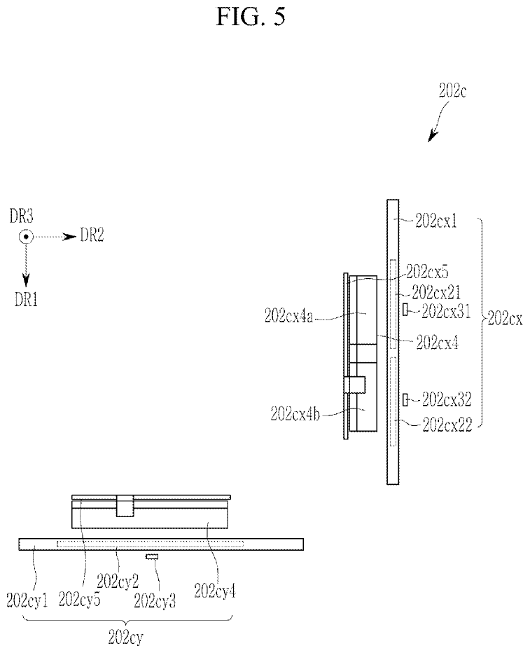

Hereinafter, a lens driver, in accordance with one or more embodiments, will be described with reference to FIG. 5. FIG. 5 illustrates a top plan view of an example lens driver, in accordance with one or more embodiments.

Referring to FIG. 5, an example lens driver 202c, in accordance with one or more embodiments, may include a first lens driver 202cx extending in parallel to the first direction DR1 and a second lens driver 202cy extending in parallel to the second direction DR2 different from the first direction DR1.

The first lens driver 202cx may include a substrate 202cx1, a plurality of coils 202cx21 and 202cx22, a first sensing portion 202cx31, a second sensing portion 202cx32, a magnet 202cx4, and a yoke 202cx5.

The plurality of coils 202cx21 and 202cx22 of the first lens driver 202cx may be formed in the substrate 202cx1. In an example, the plurality of coils 202cx21 and 202cx22 may be winding coils or fine pattern (FP) coils embedded in the substrate 202cx1. The FP coil may have an integrally formed pattern on the substrate. Additionally, the FP coil may be formed in a plate shape, so it may be easily attached to the housing 110.

The first sensing portion 202cx31 and the second sensing portion 202cx32 may include a sensor such as a Hall sensor, and may be disposed outside the plurality of coils 202cx21 and 202cx22 on the substrate 202cx1. The first sensing portion 202cx31 and the second sensing portion 202cx32 may not overlap the plurality of coils 202cx21 and 202cx22 along the first direction DR1 and the third direction DR3 in which the substrate 202cx1 extends. Additionally, each of the first sensing portion 202cx31 and the second sensing portion 202cx32 may overlap at least one of the plurality of coils 202cx21 and 202cx22 along the second direction DR2. The second direction DR2 is perpendicular to the first direction DR1 and the third direction DR3, and may be a direction in which the substrate 202cx1 and the magnet 202cx4 face each other. The first sensing portion 202cx31 may be disposed to face at least one of the plurality of coils 202cx21 and 202cx22. The second sensing portion 202cx32 may be disposed to face at least one of the plurality of coils 202cx21 and 202cx22.

The magnet 202cx4 of the first lens driver 202cx may be disposed to overlap the plurality of coils 202cx21 and 202cx22, the first sensing portion 202cx31, and the second sensing portion 202cx32 along the second direction DR2. The magnet 202cx4 may include a first magnet portion 202cx4a and a second magnet portion 202cx4b respectively facing at least one of the plurality of coils 202cx21 and 202cx22. The first magnet portion 202cx4a and the second magnet portion 202cx4b of the magnet 202Cx4 may have different magnetic poles along the first direction DR1.

[symbol]

The yoke 202cx5 may be disposed on a rear surface of the magnet 202cx4. The yoke 202cx5 may be flat along the first direction DR1. The yoke 202cx5 may include a protrusion overlapping the magnet 202cx4 along the third direction DR3.

Along the second direction DR2, the first sensing portion 202cx31 may be disposed on a surface opposite to one surface of the substrate 202cx1 on which the substrate 202cx1 and the magnet 202cx4 face each other. Thus, a space in which the first sensing portion 202cx31 may be disposed may be secured. The second sensing portion 202cx32 may be disposed on a surface opposite to one surface of the substrate 202cx1 on which the substrate 202cx1 and the magnet 202cx4 face each other. Thus, a space in which the second sensing portion 202cx32 may be disposed may be secured. Additionally, by forming the plurality of coils 202cx21 and 202cx22 of the lens driver in the substrate 202cx1, the lens driver may have a thin form factor.

Similar to the first lens driver 202cx, the second lens driver 202cy may include a substrate 202cy1, a coil 202cy2, a sensing portion 202cy3, a magnet 202cy4, and a yoke 202cy5.

The coil 202cy2 of the second lens driver 202cy may be a winding coil embedded in the substrate 202cy1 or a fine pattern (FP) coil. The FP coil may have an integrally formed pattern on the substrate. Additionally, the FP coil may be formed in a plate shape, so it may be easily attached to the housing 110.

The sensing portion 202cy3 may include a sensor such as, but not limited to, a Hall sensor, and may be disposed outside the coil 202cy2 on the substrate 202cy1. In an example, the sensing portion 202cy3 may not overlap the coil 202cy2 along the first direction DR1 and the third direction DR3 in which the substrate 202cy1 extends. Additionally, the sensing portion 202cy3 may overlap the coil 202cy2 along the second direction DR2. The second direction DR2 is perpendicular to the first direction DR1 and the third direction DR3, and may be a direction in which the substrate 202cy1 and the magnet 202cy4 face each other.

The magnet 202cy4 of the second lens driver 202cy may face the coil 202cy2 along the first direction DR1.

The yoke 202cy5 may be disposed on a rear surface of the magnet 202cy4. The yoke 202cy5 may be flat along the second direction DR2.

Along the second direction DR2, the sensing portion 202cy3 may be disposed on a surface opposite to one surface of the substrate 202cy1 on which the substrate 202cy1 and the magnet 202cy4 face each other. Thus, a space in which the sensing portion 202cy3 may be disposed may be secured. Additionally, by forming the coil 202cy2 of the lens driver in the substrate 202cy1, the lens driver may be implemented with a thin form factor.

The first sensing portion 202cx31, the magnet 202cx4, and the coil 202cx21 facing the first sensing portion 202cx31 among the plurality of coils 202cx21 and 202cx22 of the first lens driver 202cx may sense a position change of the lens barrel in a direction parallel to the second direction DR2. Additionally, the second sensing portion 202cx32, the magnet 202cx4, and the coil 202cx22 facing the second sensing portion 202cx32 among the plurality of coils 202cx21 and 202cx22 of the first lens driver 202cx may also sense a position change of the lens barrel in a direction parallel to the second direction DR2. Additionally, in order to correct the position change, the plurality of coils 202cx21 and 202cx22 and the magnet 202cx4 of the first lens driver 202cx may move the lens barrel in a direction parallel to the second direction DR2. The sensing portion 202cy3, the magnet 202cy4, and the coil 202cy2 of the second lens driver 202cy may sense a position change of the lens barrel according to a direction parallel to first direction DR1. Additionally, in order to correct the position change, the coil 202cy2 and the magnet 202cy4 of the second lens driver 202cy may move the lens barrel in a direction parallel to the first direction DR1.

In an example, the substrate 202cx1 of the first lens driver 202cx and the substrate 202cy1 of the second lens driver 202cy may be one substrate connected to each other.

As described with reference to FIG. 1 and FIG. 2, the focus adjusting driver 201 may generate a driving force to move the lens barrel 120 in the optical axis direction, for example, in the third direction DR3, and the shake correcting driver 202 may generate a driving force to move the lens barrel 120 in the first and second directions DR1 and DR2 perpendicular to the third direction DR3.

The first lens driver 202cx and the second lens driver 202cy of the lens driver 202c may be the shake correcting driver 202, and when a shaking error occurs in the camera module, they may move the lens barrel 120 in the first and second directions DR1 and DR2 perpendicular to the third direction DR3 to correct movement caused by shaking.

In an example, the first sensing portion 202cx31 and the second sensing portion 202cx32 of the first lens driver 202cx may collect sensor information according to the movement of the lens barrel 120 in the second direction DR2. The sensing portion 202cy3 of the second lens driver 202cy may collect sensor information according to the movement of the lens barrel 120 in the first direction DR1. The first sensing portion 202cx31 and the second sensing portion 202cx32 of the first lens driver 202cx and the sensing portion 202cy3 of the second lens driver 202cy may be electrically connected to the printed circuit board 163. Additionally, the first sensing portion 202cx31 and the second sensing portion 202cx32 of the first lens driver 202cx and the sensing portion 202cy3 of the second lens driver 202cy may transmit the collected sensor information to a first processor (for example, a control circuit) of the camera module 100 through the printed circuit board 163 or a second processor of the electronic device on which the camera module 100 is mounted. The printed circuit board 163 may be connected to the first processor (or the control circuit) related to driving the camera module 100 or the second processor of the electronic device on which the camera module 100 is mounted.

According to the control of at least one of the first processor and the second processor, the printed circuit board 163 may supply a signal of a specified magnitude (for example: a current of a specified magnitude) to at least one of the plurality of coils 202cx21 and 202cx22 and the coil 202cy. Accordingly, rotation occurring in the lens module 120 may be compensated to prevent deterioration of image quality of the camera module 100. As a specific example, at least one of the plurality of coils 202cx21 and 202cx22 may be controlled so that a sum of a value of the sensor information according to the movement of the lens barrel 120 in the second direction DR2 collected by the first sensing portion 202cx31 of the first lens driver 202cx and a value of the sensor information according to the movement of the lens barrel 120 in the second direction DR2 collected by the second sensing portion 202cx32 of the first lens driver 202cx becomes zero. In this example, processing such as linear regression may be performed on the sensor information.

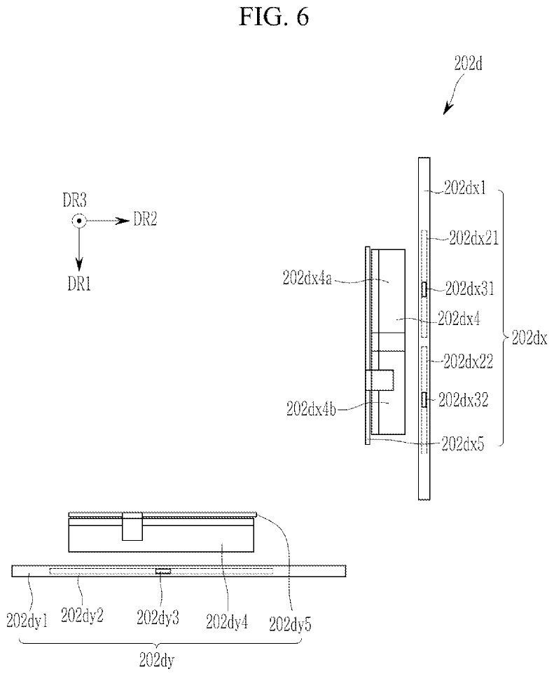

Hereinafter, an example lens driver, in accordance with one or more embodiments, will be described with reference to FIG. 6. FIG. 6 illustrates a top plan view of an example lens driver, in accordance with one or more embodiments.

Referring to FIG. 6, a lens driver 202d, in accordance with one or more embodiments, may include a first lens driver 202dx, extending in parallel to the first direction DR1, and a second lens driver 202dy, extending in parallel to the second direction DR2 different from the first direction DR1.

The first lens driver 202dx may include a substrate 202dx1, a plurality of coils 202dx21 and 202dx22, a first sensing portion 202dx31, a second sensing portion 202dx32, a magnet 202dx4, and a yoke 202dx5.

The plurality of coils 202dx21 and 202dx22 of the first lens driver 202dx may be formed in the substrate 202dx1. In an example, the plurality of coils 202dx21 and 202dx22 may be winding coils or fine pattern (FP) coils embedded in the substrate 202dx1. The FP coil may have an integrally formed pattern on the substrate. Additionally, the FP coil may be formed in a plate shape, so it may be easily attached to the housing 110.

The first sensing portion 202dx31 and the second sensing portion 202dx32 may include a sensor such as, but not limited to, a Hall sensor, and may be disposed outside the plurality of coils 202dx21 and 202dx22 on the substrate 202dx1. The first sensing portion 202dx31 and the second sensing portion 202dx32 may overlap at least one of the plurality of coils 202dx21 and 202dx22 along the first direction DR1 and the third direction DR3 in which the substrate 202dx1 extends. Additionally, each of the first sensing portion 202dx31 and the second sensing portion 202dx32 may overlap at least one of the plurality of coils 202dx21 and 202dx22 along the second direction DR2. The second direction DR2 is perpendicular to the first direction DR1 and the third direction DR3, and may be a direction in which the substrate 202dx1 and the magnet 202dx4 face each other.

The magnet 202dx4 of the first lens driver 202dx may be disposed to face the plurality of coils 202dx21 and 202dx22, the first sensing portion 202dx31, and the second sensing portion 202dy32 along the second direction DR2. The magnet 202dx4 may include a first magnet portion 202dx4a and a second magnet portion 202dx4b respectively facing at least one of the plurality of coils 202dx21 and 202dx22. The first magnet portion 202dx4a and the second magnet portion 202dx4b may have different magnetic poles along the first direction DR1.

The yoke 202dx5 may be disposed on a rear surface of the magnet 202dx4. The yoke 202dx5 may be flat along the first direction DR1. The yoke 202dx5 may include a protrusion overlapping the magnet 202dx4 along the third direction DR3.

Along the second direction DR2, the first sensing portion 202dx31 may be disposed inside the coil 202dx21 overlapping the first sensing portion among the plurality of coils 202dx21 and 202dx22, and may be embedded inside the substrate 202dx1. Thus, a space in which the first sensing portion 202dx31 may be disposed may be secured. The second sensing portion 202dx32 may be disposed inside the coil 202dx22 overlapping the second sensing portion among the plurality of coils 202dx21 and 202dx22, and may be embedded inside the substrate 202dx1. Thus, a space in which the second sensing portion 202dx32 may be disposed may be secured. Additionally, by forming the plurality of coils 202dx21 and 202dx22 of the lens driver in the substrate 202dx1, the lens driver may be implemented with a thin form factor.

Similar to the first lens driver 202dx, the second lens driver 202dy may include a substrate 202dy1, a coil 202dy2, a sensing portion 202dy3, a magnet 202dy4, and a yoke 202dy5.

The coil 202dy2 of the second lens driver 202dy may be a winding coil embedded in the substrate 202dy1 or a fine pattern (FP) coil. The FP coil may have an integrally formed pattern on the substrate. Additionally, the FP coil may be formed in a plate shape, so it may be easily attached to the housing 110.

The sensing portion 202dy3 may include a sensor such as, but not limited to, a Hall sensor, and may be disposed outside the coil 202dy2 on the substrate 202dy1. The sensing portion 202dy3 may overlap the coil 202dy2 along the first direction DR1 and the third direction DR3 in which the substrate 202dy1 extends. Additionally, the sensing portion 202dy3 may overlap the coil 202dy2 along the second direction DR2. The second direction DR2 is perpendicular to the first direction DR1 and the third direction DR3, and may be a direction in which the substrate 202dy1 and the magnet 202dy4 face each other.

The magnet 202dy4 of the second lens driver 202dy may be disposed to face the coil 202dy2 and the sensing portion 202dy3 along the first direction DR1.

The yoke 202dy5 may be disposed on a rear surface of the magnet 202dy4. The yoke 202dy5 may be flat along the second direction DR2.

Along the second direction DR2, the sensing portion 202dy3 may be disposed inside the coil 202dy2 and embedded inside the substrate 202dx1. Thus, a space in which the second sensing portion 202dx32 may be disposed may be secured. Additionally, by forming the coil 202dy2 of the lens driver in the substrate 202dy1, the lens driver may be implemented with a thin form factor.

The first sensing portion 202dx31, the magnet 202dx4, and the coil 202dx21 facing the first sensing portion 202dx31 among the plurality of coils 202dx21 and 202dx22 of the first lens driver 202dx may sense a change in the position of the lens barrel in a direction parallel to the second direction DR2. Additionally, the second sensing portion 202dx32, the magnet 202dx4, and the coil 202dx22 facing the second sensing portion 202dx32 among the plurality of coils 202dx21 and 202dx22 of the first lens driver 202dx may also sense a change in the position of the lens barrel in a direction parallel to the second direction DR2. Additionally, in order to correct the position change, the plurality of coils 202dx21 and 202dx22 and the magnet 202dx4 of the first lens driver 202dx may move the lens barrel in a direction parallel to the second direction DR2. The sensing portion 202dy3, the magnet 202dy4, and the coil 202dy2 of the second lens driver 202dy may sense a position change of the lens barrel according to a direction parallel to first direction DR1. Additionally, in order to correct the position change, the coil 202dy2 and the magnet 202dy4 of the second lens driver 202dy may move the lens barrel in a direction parallel to the first direction DR1.

In an example, the substrate 202dx1 of the first lens driver 202dx and the substrate 202dy1 of the second lens driver 202dy may be one substrate connected to each other.

As described with reference to FIG. 1 and FIG. 2, the focus adjusting driver 201 may generate a driving force to move the lens barrel 120 in the optical axis direction, for example, in the third direction DR3, and the shake correcting driver 202 may generate a driving force to move the lens barrel 120 in the first and second directions DR1 and DR2 perpendicular to the third direction DR3.

The first lens driver 202dx and the second lens driver 202dy of the lens driver 202d may be the shake correcting driver 202, and when a shaking error occurs in the camera module, they may move the lens barrel 120 in the first and second directions DR1 and DR2 perpendicular to the third direction DR3 to correct movement caused by shaking.

In an example, the first sensing portion 202dx31 and the second sensing portion 202dx32 of the first lens driver 202dx may collect sensor information according to the movement of the lens barrel 120 in the second direction DR2. The sensing portion 202dy3 of the second lens driver 202dy may collect sensor information according to the movement of the lens barrel 120 in the first direction DR1. The first sensing portion 202dx31 and the second sensing portion 202dx32 of the first lens driver 202dx and the sensing portion 202dy3 of the second lens driver 202dy may be electrically connected to the printed circuit board 163. Additionally, the first sensing portion 202dx31 and the second sensing portion 202dx32 of the first lens driver 202dx and the sensing portion 202dy3 of the second lens driver 202dy may transmit the collected sensor information to a first processor (for example, a control circuit) of the camera module 100 through the printed circuit board 163 or a second processor of the electronic device on which the camera module 100 is mounted. The printed circuit board 163 may be connected to the first processor (or the control circuit) related to driving the camera module 100 or the second processor of the electronic device on which the camera module 100 is mounted.

According to the control of at least one of the first processor and the second processor, the printed circuit board 163 may supply a signal of a specified magnitude (for example: a current of a specified magnitude) to at least one of the plurality of coils 202dx21 and 202dx22 and the coil 202dy2. Accordingly, rotation occurring in the lens module 120 may be compensated to prevent deterioration of image quality of the camera module 100. As a specific example, at least one of the plurality of coils 202dx21 and 202dx22 may be controlled so that a sum of a value of the sensor information according to the movement of the lens barrel 120 in the second direction DR2 collected by the first sensing portion 202dx31 of the first lens driver 202dx and a value of the sensor information according to the movement of the lens barrel 120 in the second direction DR2 collected by the second sensing portion 202dx32 of the first lens driver 202dx becomes zero. In this example, processing such as linear regression may be performed on the sensor information.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A lens driver, comprising
a plurality of first coils disposed on a first substrate that extends in a first direction,
a second coil disposed on a second substrate that extends in a second direction different from the first direction,
a first sensing portion disposed on the first substrate, and disposed external to the plurality of first coils so as to not overlap the plurality of first coils along the second direction,
a first magnet including a first magnet portion and a second magnet portion that are respectively disposed to face at least one of the plurality of first coils along the second direction, and configured to have different magnetic poles along the first direction, and
a second magnet disposed to face the first sensing portion along the second direction,
wherein a second distance between the first substrate and the second magnet along the second direction is greater than a first distance between the first substrate and the first magnet along the second direction.

2. The lens driver of claim 1, wherein:
the first sensing portion is disposed between the first substrate and the second magnet.

3. The lens driver of claim 1, wherein:
a thickness of the first magnet along the second direction is different from a thickness of the second magnet along the second direction.

4. The lens driver of claim 1, wherein:
the plurality of first coils are fine pattern (FP) coils which have a pattern integrally formed on the first substrate.

5. The lens driver of claim 1, further comprising:
a second sensing portion disposed on the second substrate and disposed external to the second coil so as to not overlap the second coil along the first direction,
a third magnet disposed to face the second coil along the first direction, and
a fourth magnet disposed to face the second sensing portion along the first direction,
wherein a fourth distance between the second substrate and the fourth magnet along the first direction is greater than a third distance between the second substrate and the third magnet along the first direction.

6. The lens driver of claim 5, wherein:
the second sensing portion is disposed between the second substrate and the fourth magnet.

7. The lens driver of claim 5, wherein:
a thickness of the third magnet along the first direction is different from a thickness of the fourth magnet along the first direction.

8. The lens driver of claim 1, wherein:
the second coil is a fine pattern (FP) coil which has a pattern integrally formed on the second substrate.

9. The lens driver of claim 1, further comprising:
a first yoke disposed on a rear surface of the first magnet, and a second yoke disposed on a rear surface of the second magnet,
wherein the first yoke includes a protrusion that overlaps the first magnet along a third direction perpendicular to the first direction and the second direction, and
wherein the second yoke includes a protrusion that overlaps the second magnet along the third direction.

10. The lens driver of claim 1, further comprising:
a third sensing portion disposed on the first substrate and disposed external to the plurality of first coils so as to not overlap the plurality of first coils along the second direction, and
a fifth magnet disposed to face the third sensing portion along the second direction,
wherein a third distance between the first substrate and the fifth magnet along the second direction is greater than the first distance between the first substrate and the first magnet.

11. The lens driver of claim 10, wherein:
the third sensing portion is disposed between the first substrate and the fifth magnet.

12. The lens driver of claim 10, wherein:
a thickness of the first magnet along the second direction is different from a thickness of the fifth magnet along the second direction.

13. The lens driver of claim 10, further comprising:
a third yoke disposed on a rear surface of the fifth magnet,
wherein the third yoke includes a protrusion that overlaps the fifth magnet along the third direction perpendicular to the first direction and the second direction.

14. The lens driver of claim 10, further comprising:
a first connection member configured to connect the first magnet and the second magnet, and
a second connection member configured to connect the first magnet and the fifth magnet.

15. The lens driver of claim 14, wherein:
the first connection member and the second connection member are respectively disposed at a first end of the first magnet and a second end of the first magnet along the first direction.

16. A lens driver comprising:
a plurality of first coils disposed on a first substrate that extends in a first direction,
a second coil disposed on a second substrate that extends in a second direction different from the first direction,
a plurality of first sensing portions disposed to respectively overlap the plurality of first coils of the first substrate along the second direction,
a second sensing portion disposed to overlap the second coil of the second substrate along the first direction,
a first magnet including a first magnet portion and a second magnet portion that are respectively disposed to face at least one of the plurality of first coils along the second direction, and configured to have different magnetic poles along the first direction, and
a second magnet disposed to face the second coil along the first direction,
wherein the plurality of first coils and the second coil are fine pattern (FP) coils which have a pattern integrally formed on a substrate.

17. The lens driver of claim 16, wherein:
each of the plurality of first sensing portions is disposed inside the plurality of first coils.

18. The lens driver of claim 16, wherein:
the plurality of first sensing portions are embedded inside the first substrate.

19. The lens driver of claim 16, wherein:
the first magnet is disposed to overlap the plurality of first coils and the plurality of first sensing portions along the second direction.

20. The lens driver of claim 16, further comprising:
a first yoke disposed on a rear surface of the first magnet, and a second yoke disposed on a rear surface of the second magnet,
wherein the first yoke includes a protrusion that overlaps the first magnet along a third direction perpendicular to the first and second directions, and
wherein the second yoke includes a protrusion that overlaps the second magnet along the third direction.
